(19) United States
(12) Patent Application Publication
(10) Pub. No.: US 2005/0028670 A1
(43) Pub. Date: Feb. 10, 2005

(54) Ionically crosslinked molecular thin film

(76) Inventor: Steven L. Regen, Allentown, PA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/862,574

(22) Filed: Jun. 8, 2004

Related U.S. Application Data
(60) Provisional application No. 60/476,619, filed on Jun. 9, 2003.

(51) Int. Cl. B01D 53/22

(52) U.S. Cl. 95/45

(57) ABSTRACT

The present invention relates to a Langmuir-Blodgett (LB) thin film, which includes: at least one molecular layer, which includes one or more monolayer-forming surfactant molecules having a first ionic charge, ionically cross-linked with at least one water-soluble agent having a second ionic charge; wherein a total amount of the first and second charges is at least 5; and wherein each of the first and second charges is independently 2 or greater. The present invention also relates to novel polymerizable surfactant compounds as well as articles and methods using the thin film, and methods of making the thin film.

### BACKGROUND OF THE INVENTION

1. Field of the Invention

The present invention relates to a molecular thin film, articles made with same, methods of making, and methods of using. This material is supported in part by the U.S. Army RMAC, Natick Contracting Div., Natick, Mass. under Contract No. DAAD16-02-C-0051.

2. Description of the Related Art

Gases are widely used in many industries, such as medical care, metal and chemical processing, electronic processing, petroleum refining and water treatment and their use is rapidly growing. Providing gases of high purity is important in gas separation. Because of the high competition in the marketplace, however, high purity and energy-cost efficient processes are especially desirable in order to increase profit margins.

With the increasing concern about global warming, removal of carbon dioxide from emission sources, such as power stations and steelworks is attracting considerable interest. Removing CO₂ from domestic natural gas is another important application of carbon dioxide separation.

Besides the applications cited above, other processes, such as oxygen-enriched combustion air to reduce fuel consumption, natural gas dehydration, and air dehydration, all require gas separation science and technology.

Membrane technology has become increasingly important in the industrial separation of gases. A membrane refers to a thin barrier, either a solid (inorganic or organic) or a liquid that separates two phases (Baker R. W. Membrane Technology and Applications, McGraw Hill: NY, 2000, chapter 8; Henis, J. S.; Tripodi, M. K. The Development Technology of Gas Separation Membranes, Science, 1983, 220, 4592-4594). The separation of gases is then achieved based on the differences in permeation rates of the species through the membrane. The driving force for permeation results from a concentration or pressure difference of the permeating species between the upstream and the downstream. Compared with other gas separation methods, the advantages of membrane separation lie in simplicity and low energy cost. See, for example, FIG. 1.

Most of the innovations in gas separation membranes in the past have come from improvements in membrane materials.

While non-polymeric molecular sieves have excellent separation properties, the expenses involved in producing and packaging them have prevented their use in large-scale membrane modules.

Thus, discovering new materials with separation properties without losing the economical feasibility of polymeric membrane materials would be a major break-through for this field.

Langmuir-Blodgett (LB) films are monolayer and multilayer films transferred from a liquid-air interface onto a substrate (Roberts, G. Langmuir-Blodgett films; Plenum Press: NY, 1990; Ulman, A Introduction to Ultra-thin Organic Films, From Langmuir-Blodgett to Self-Assembly; Academic Press: San Diego, 1991). LB films have been the subject of considerable interest for almost 70 years (U.S. Pat. No. 2,220,860; Blodgett, K. A. Films Built by Depositing Successive Monomolecular Layers on a Solid Surface, J. Am. Chem. Soc. 1935, 57, 1007-1022). The idea of using LB film as molecular sieving materials can be traced to early pioneering studies by Katherine Blodgett. The basic idea is that the tightly packed and ordered surfactant multilayers would have regular void spaces in molecular scale, capable of separating molecules based on their size. Because of the extreme thinness of these layers (several nanometers/layer), the permeation resistance is expected to be small. Despite this interest, problems with film quality and stability have hampered efforts that have been aimed at developing them from a practical standpoint. To date, the quality of the majority of the LB films that have been reported has been poor (Riedl, T.; Nitsch, W.; Michel T. Gas Permeation of LB films: characterization and application, Thin Solid Films 2000, 379, 240-252), as evidenced by their poor gas permeation selectivities that approach values predicted by Graham's law. Such a finding indicates that diffusion takes place through defects in the film. Reductions in the normalized fluxes have been observed, without much improvement in selectivity (Hendel, R. Ultra-thin Calix(n)arene Langmuir-Blodgett Films for Gas Separations, Ph. D. Dissertation, Lehigh University, 1998). Although there have been several reports of the use of polyions to stabilize monolayers made from singly-charged surfactants (Shimomura,M.; Kunitake, T. Thin Solid Films, 1985, 132, 243; Chi, L. F.; Johnston, R. R.; Ringsdorf, H. Langmuir, 1991, 7, 2323; Bruinsma, P. J.; Stroeve, P.; Hoffmann, C. C.; Rabolt, J. F. Thin Solid Films, 1996, 284-285, 713) there is room for improvement in producing a stable LB film membrane.

Thus, it would be desirable to achieve a gas separation membrane that has attractive gas permeation properties including permeability and selectivity, yet which is also mechanically durable.

### SUMMARY OF THE INVENTION

One object of the present invention is to provide a gas separation membrane that has attractive gas permeation properties.

Another object of the present invention is to provide a gas separation membrane having excellent permeability and selectivity.

Another object of the present invention is to provide a gas separation membrane that is durable.

These and other objects have been achieved by the present invention, the first embodiment of which provides a Langmuir-Blodgett (LB) thin film, which includes
at least one molecular layer, which includes one or more monolayer-forming surfactant molecules having a first ionic charge, ionically cross-linked with at least one water-soluble agent having a second ionic charge;
wherein a total amount of said first and second charges is at least 5;
and wherein each of said first and second charges is independently 2 or greater.

Another embodiment of the invention provides an article, which includes the above thin film in contact with at least one support.

Another embodiment of the invention provides a method for making the above thin film of claim 1, which includes contacting at least a portion of a monolayer of the surfactant with the agent, and ionically cross-linking the monolayer.

Another embodiment of the invention provides a method for making the above article, which includes contacting the thin film with the support.

Another embodiment of the invention provides a method, which includes contacting the above thin film with a mixture of gases.

Another embodiment of the invention provides a method, which includes contacting the article above with a mixture of gases.

Another embodiment of the invention provides a method for stabilizing a Langmuir-Blodgett film, which includes contacting at least one molecular layer comprising one or more monolayer-forming surfactant molecules having a first ionic charge with at least one water-soluble agent having a second ionic charge;
wherein a total amount of said first and second charges is at least 5;
and wherein each of said first and second charges is independently 2 or greater;
to ionically crosslink said molecular layer.

Another embodiment of the invention provides a method, which includes:
hydrating the thin film above, to form a hydrated thin film; and
contacting the hydrated thin film with a mixture of gases.

Another embodiment of the invention provides an article, which includes:
the thin film above, disposed within a pressure vessel having at least one inlet and at least one outlet.

Another embodiment of the invention provides a compound having the formula: 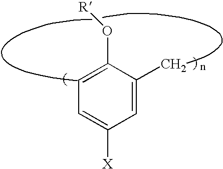
wherein R′=C₄-C₂₀ is linear or branched, saturated or unsaturated alkyl, aryl, and/or acyl group;
wherein n is 4 to 8; and
wherein X=a trimethylammonium, trimethylammoniummethyl, trimethylphosphonium, methylene trimethylphosphonium, sulfonium, sulfate, carboxymethyl, carboxylate, and combinations thereof.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic illustration of a membrane gas separation.

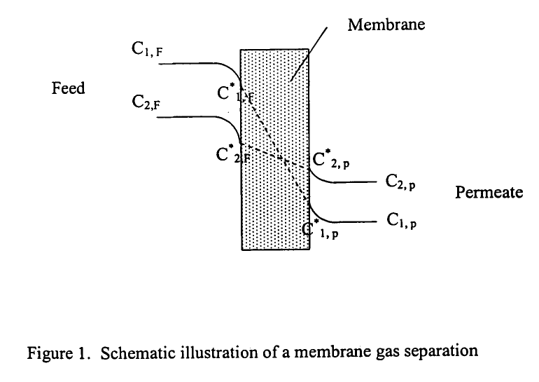

FIG. 2. Poly(4-styrenesulfonate) (PSS) has been used to ionically cross-link (glue together) a single Langmuir-Blodgett bilayer derived from an amphiphilic calix(6)arene (1) bearing six hexadecyl and six methylene-trimethyammonium groups. The resulting film is of high quality and robustness, as judged by its He/N₂ permeation selectivity and by its ability to withstand exposure to chloroform solvent. The creation of a stable organic membrane, having a thickness that is less than 6 nm and a He/N₂ permeation selectivity of ca. 305, represents a milestone for LB technology.

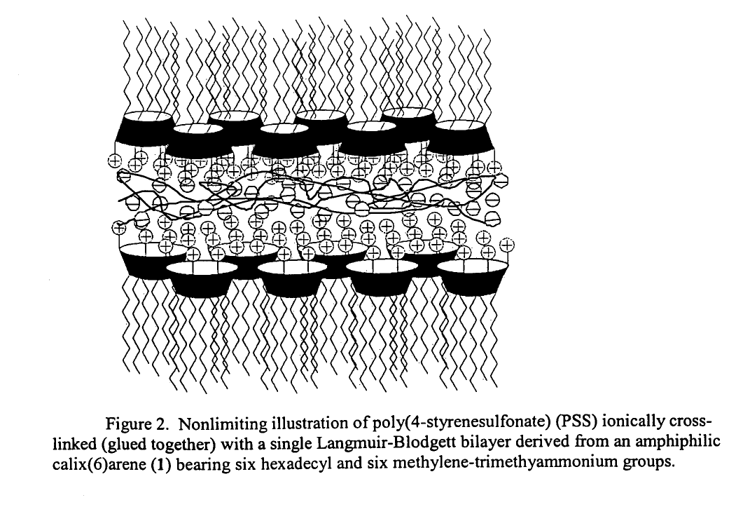

FIG. 3 shows preferred configurations of membrane modules. A. plate and frame module, B. hollow fiber module, C. spiral-wound module.

FIG. 4 shows preferred a calix(n)arene and glue.

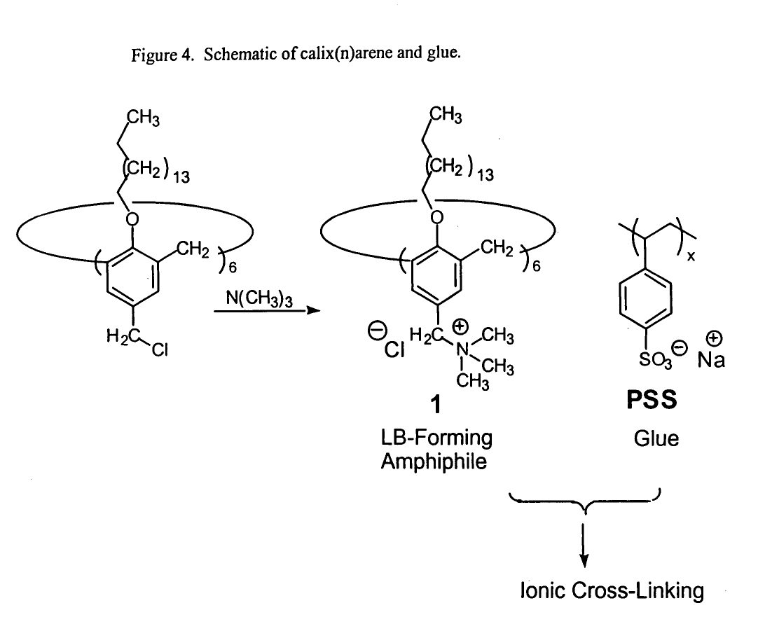

### DETAILED DESCRIPTION OF THE PREFERRED EMBODIMENTS

Various other objects, features and attendant advantages of the present invention will be more fully appreciated as the same becomes better understood from the following detailed description of the preferred embodiments of the invention.

Preferred examples of monolayer-forming surfactants include cyclic or acyclic surfactants.

Preferred examples of cyclic surfactants include: 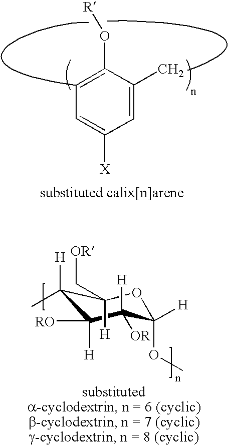
wherein R′=C₄-C₂₀ is linear or branched, saturated or unsaturated alkyl, aryl, and/or acyl groups; and
wherein X=a trimethylammonium, trimethylammoniummethyl, trimethylphosphonium, methylene trimethylphosphonium, mercuronium, sulfonium, sulfate, carboxymethyl and/or carboxylate;
and wherein R=sulfate or carboxymethylene. Combinations are possible.

Preferred examples of cyclodextrin-based surfactants include those in which R′=C₄-C₂₀ linear or branched, saturated or unsaturated alkyl, aryl or acyl groups and R=sulfate or carboxymethylene.

Preferred examples of acyclic surfactants include:

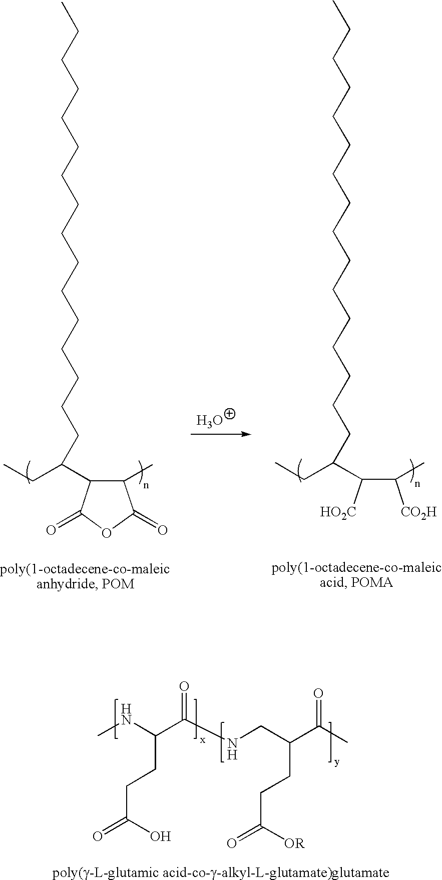

In the formulas recited, n may be 2, 3, 4, 5, 6, 7, 8, 9, 10, 12, 14, 16, 18, 20, 30, 50, 70, 90, 300, 500, 700, 1000, 10,000, any combination thereof, and greater. For the claix(n)arenes, an n value ranging form 4 to 8 is preferred. combinations are possible.

In the formulas recited, x may be that for a mole fraction of 0.1 to 0.8, based on the polymer. This range includes all values and subranges therebetween, including 0.1, 0.2, 0.3, 0.4, 0.5, 0.6, 0.7 and 0.8. Taken another way, x may be 1, 2, 3, 4, 5, 6, 7, 8, 9, 10, 15, 20, 30, 50, 70, 90, 150, 300, 700, 1000, 10,000, any combination thereof, and greater.

In the formulas recited, y may be that for a mole fraction of 0.2 to 0.9, based on the polymer. This range includes all values and subranges therebetween, including 0.2, 0.3, 0.4, 0.5, 0.6, 0.7, 0.8, and 0.9. Taken another way, y may be 2, 3,4,5, 6, 7, 8, 9, 10, 15, 20, 30, 50, 70, 90, 150, 300, 700, 1000, 10,000, any combination thereof, and greater.

The C₄-C₂₀ groups referred to above may be selected from the group including C₄, C₅, C₆, C₇, C₈, C₉, C₁₀, C₁₁, C₁₂, C₁₃, C₁₄, C₁₅, C₁₆, C₁₇, C₁₈, C₁₉ and C₂₀.

The monolayer-forming surfactant may exist as a charged moiety (cationic, anionic or zwitterionic) or in an ionically neutral state. The neutral state preferably includes one or more counterions, which may include halogen, chloride, bromide, iodide, fluoride, hydroxide, proprionate, acetate, formate, bicarbonate, cyanide, carbonate, phosphate, oxalate, sulfate, hydrogen sulfate, sulfite, phosphonite, tartrate, citrate, hydronium, sodium, lithium, ammonium, potassium. These may also be present in the ionically crosslinked moiety. Combinations are possible.

Mixed monolayers, in which more than one kind of monolayer-forming surfactant is included in the layer, are possible.

Other monolayer-forming molecules which may optionally be incorporated into the monolayer in addition to the ionically crosslinkable monolayer forming surfactants include stearic acid, arachidic acid, linoleic acid, combinations thereof, and the like.

Preferred examples of water-soluble agents include:
poly(4-styrene sulfonic acid)
poly(4-styrenesulfonic acid-co-maleic acid)
poly(styrene-co-maleic acid)
Acid Blue 113
Acid Blue 92
Ponceau S
Brilliant Black BN
poly(allyl)amine
poly(diallyldimethylammonium chloride)
Ca⁺⁺
Fe(II)
Fe(III)
Ti(IV)
Hg(II).

Each of the surfactants and water-soluble agents may be used individually or in combination as appropriate.

The ammonium substituted calix(n)arene above may be synthesized by direct quaternization of the corresponding alkyl halide. Other preferred routes are given in the schemes below. In the schemes, the numeration is as follows:
1) trimethylammoniummethyl
2) trimethlyammonium
3) trimethylphosphonium
4) methylenetrimethylphosphonium
5) mercuronium
6) sulfonium
7) sulfate
8) carboxymethyl
9) carboxylate.

### Preferred Routes to Substituted Calixarenes

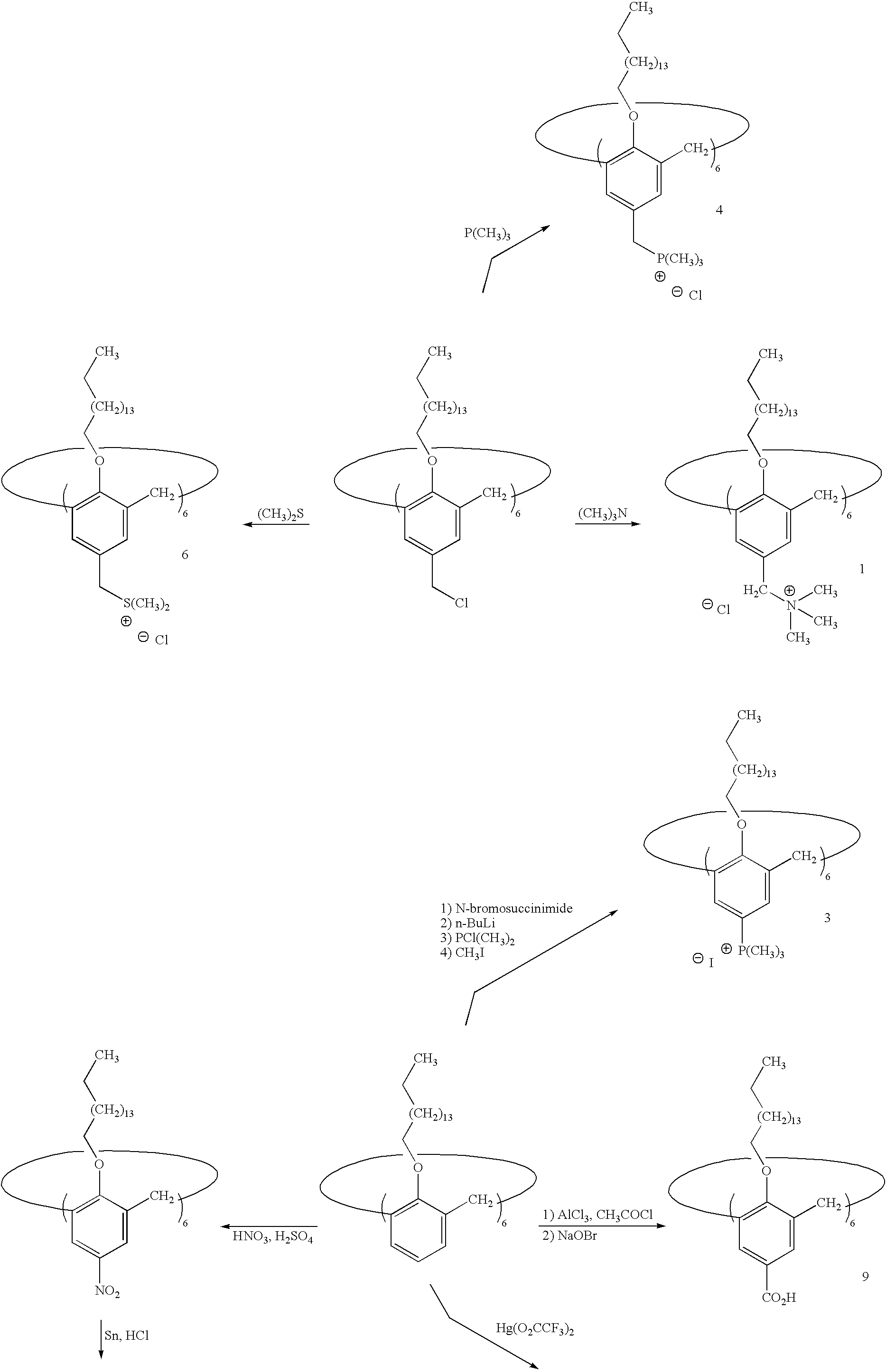

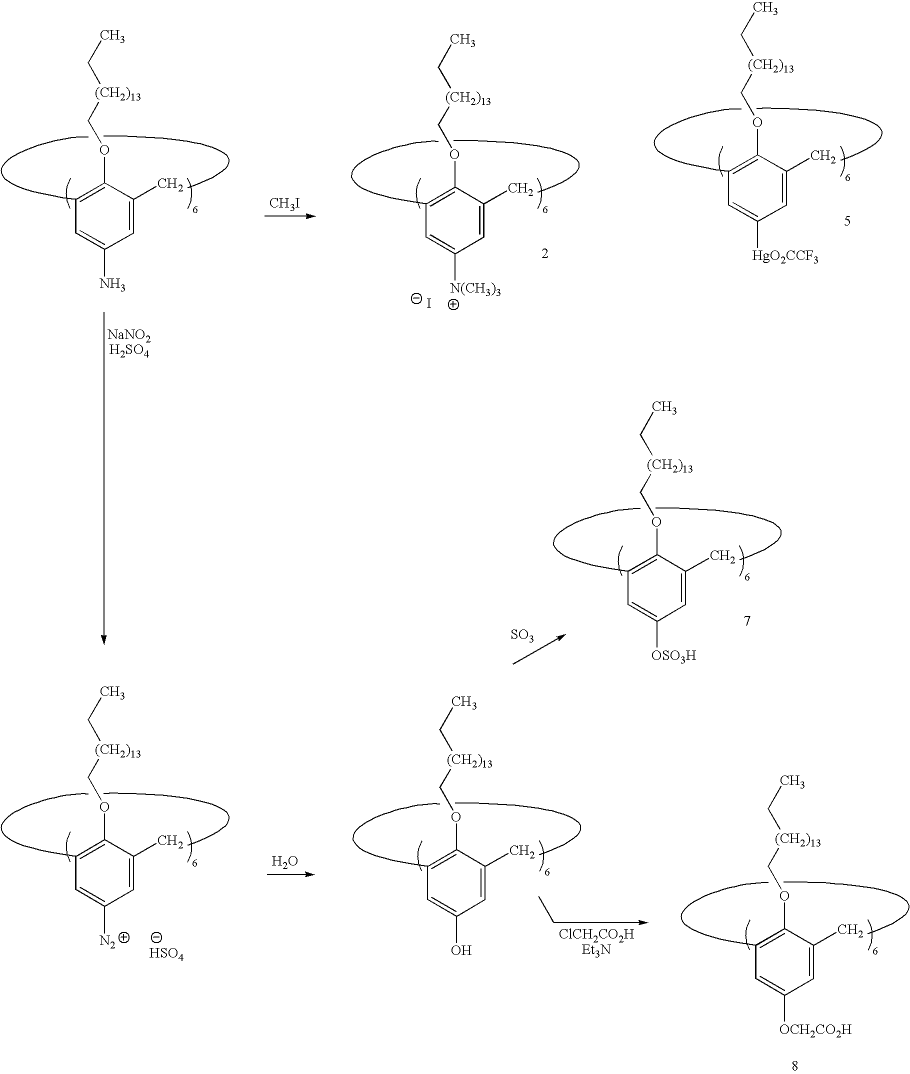

One preferred embodiment of the present invention provides “glued” Langmuir-Blodgett (LB) bilayers; that is, LB bilayers that include two monolayer leaflets, each of which is ionically cross-linked. In one preferred embodiment, calix(6)arene (having structure 1) is the bilayer-forming amphiphile and poly(4-styrenesulfonate) (PSS) is the glue. The fact that a single glued bilayer of 1/PSS shows very high gas permeation selectivity and robustness is both surprising and unexpected.

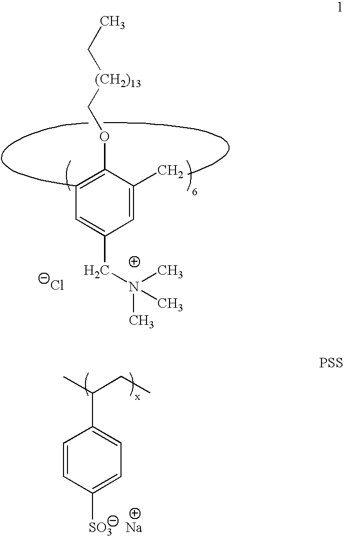

One preferred embodiment of the present invention relates to 5,11,17,23,29,35-hexakis((N,N,N-trimethylammonium)-N-methyl-37,38,39,40,41,42-hexakis-n-hexamedecyloxy-calix(6)arene hexachloride (Structure 1 above) and the synthesis thereof.

As noted above, the synthesis may be carried out by direct quatemization of the corresponding alkyl halide. Preferably, an ethaniolic solution of trimethylamine is added to a solution of 5,11,17,23,29,35-hexa(chloromethyl)-37,38,39,40,41,42-hexakis-n-hexadecyloxy-calix(6)arene, and reaction is allowed to proceed preferably at elevated temperatures and preferably in a sealed container, until the product is obtained as the precipitated salt.

Preferably, the reaction temperature is 30-70° C., which includes 35, 40, 45, 50, 55, 60, 65 and 70° C. Preferably, the reaction time ranges from 0.5-4 hrs, which range includes 0.6, 0.8, 1, 2, 3 and 4 h. The resulting precipitate may then be worked up with trituration and recrystallization as appropriate.

One preferred embodiment provides a thin film based on the combination of calix(6)arene-based amphiphiles and poly(1-(trimethylsilyl)-1-propyne) (PTMSP) supports.

With the present invention, significant improvements are possible using cationic calix(6)arenes together with water soluble polyanions.

While not wishing to be bound by theory, it is believed that the water soluble polyanions glue together such LB bilayers via ionic cross-linking, and help to fill void space within the film assembly; the net result being enhanced stability, reduced defect formation and increased permeation selectivity. The present invention also makes it possible to stabilize LB films. The combined use of a polyion and multiply-charged surfactants (required for gluing) is without precedent. The thin films according to the present invention have particularly attractive permeability and stability properties.

The Langmuir-Blodgett method is known.

Preferably, aqueous solutions of water soluble agent (for the subphase) have an agent. concentration ranging from 0.01 to 100 mM, which range includes 0.05, 0.07, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, and 100 mM. The pH of the aqueous solution may range from 1 to 12, which range includes 1, 2, 3, 3.5, 4, 4.5, 5, 5.5, 6, 6.5, 7, 7.5, 8, 8.5, 9, 9.5, 10, 11 and 12 and may be adjusted with known acids, bases and/or buffers. The pH is preferably adjusted with NaOH.

The subphase containing the water soluble agent is contacted with the clean LB trough. Alternatively, the monolayer film may be formed on a water subphase (without the agent) and the water soluble agent added later. Preferably, the subphase containing the water soluble agent is put into the trough before the surfactant is added to the subphase surface, however.

The subphase may be allowed to equilibrate once in the trough for a time ranging from 5 minutes to 3 hours, which range includes 10, 20, 30, 40, 50, 60 minutes, and 1.3, 1.5, 1.7, 1.9, 2, 2.1, 2.3, 2.5, 2.7, and 2.9 hours, before the surfactant is applied.

The subphase temperature is preferably constant and may range from 10 to 40° C., which includes 10, 15, 20, 25, 30, 35, and 40° C. Preferably, 25° C. is used.

The surfactant solution may be prepared using one or more organic solvents such as chloroform, methanol, dichloromethane, acetone, and/or toluene. Mixtures are possible. Preferably, the solvent should be HPLC grade. Solvents may be used in v/v ratios ranging from 10:1 to 1:1, which ratios include 10, 9, 8, 7, 6, 5, 4, 3, 2, and 1:1.

Surfactant solution concentration may range from 0.01 to 10 mg/ml (i.e., mg surfactant/ml solution), which range includes 0.05, 0.1, 0.5, 1, 2, 3, 4, 5, 6, 7, 8, 9 and 10 mg/ml.

Surfactant solution may be applied to the subphase (aqueous solution of water soluble agent solution) in single or repeated aliquats, e.g., 0.1, 1, 2.5, 5, 10, 20, 25, 50, and 100 μL.

The subphase surface area is not particularly limiting at the time of spreading, and may range from just a few to several thousand cm². Depending on the type of trough used, the subphase area at the time of spreading may be 5, 10, 15, 20, 25, 50, 75, 100, 300, 500, 600, 900, 1000, 2000, 5000 cm².

After spreading, the organic solvent may be allowed to evaporate, leaving the surfactant substantially or completely on the surface of the subphase. The evaporation time may range from 5 minutes to over an hour, which range includes 5, 10, 15, 20, 20, 40, 50, 60, minutes, and 1.5, 2, 3 hours or more.

After evaporation, the surfactant remaining on the subphase surface is compressed and preferably until a surfactant monolayer is present on the subphase surface. The rate of compression may range from 2-200 cm²/min, which range includes 2, 3, 5, 7, 9, 10, 15, 20, 25, 30, 40, 50, 60, 70, 80, 90, 100, 120, 140, 160, 180 and 200 cm²/min.

The surface pressure of a monolayer film may be dependent upon the type of surfactant used. The optimum surface pressure for deposition may range from 1 to 100 dyn/cm, which range includes 2, 3, 4, 5, 6, 7, 8, 9, 10, 15, 20, 23, 25, 27, 29, 30, 31, 33, 35, 37, 39, 40,45, 50, 60, 70, 80, 90, and 100 dyn/cm.

Once at the desired surface pressure, the monolayer film may optionally be allowed to equilibrate before the film is deposited onto a substrate surface. The equilibration time may range from 1 minute to 2 hours, which range includes 5, 10, 20, 30, 40, 50, 60, 70, 80, 90, 100, and 120 minutes. Preferably, the equilibration is carried out at constant surface pressure.

Ionic cross linking typically commences at the time the monolayer forming surfactant contacts the water soluble agent.

To deposit the layer or layers (“dipping”), a “down only”, “down-up”, “up-only” or “up-down” stroke or combination thereof may be used as appropriate depending on the material layer and/or on the configuration desired. A single layer, multiple layers, or multiple layers of different types of materials may be deposited onto the substrate alone or in combination.

For deposition, the dipping rate may range from 0.1 mm/min to 50 mm/min may be used, which range includes 0.1, 0.3, 0.5, 0.7, 0.9, 1, 2, 3, 4, 5, 6, 7, 8, 9, 10, 15, 20, 25, 30, 35, 40, 45 and 50 mm/min. was typically 4 mm/min or 2 mm/min.

At the end of each dipping stroke, the dipper may be stopped (i.e., delayed) for 10 s˜3 hours prior to the return trip, which range includes 20, 30, 45 s, 1, 5, 10, 20, 25, 50, 60, 75, 85, 90, 120, 150, 180, 220, and 240 minutes.

The transfer ratio (R) is defined as the decrease in monolayer area at the air-water interface divided by the geometrical surface area of the substrate. The transfer ratio may range from 0.5 to 2, which range includes 0.7,0.9, 1, 1.1, 1.3, 1.5, 1.7, 1.9 and 2.

The LB films may be produced in batchwise or continuous fashion. Some continuous methods are given in: O. Albrecht, K. Eguchi, H. Matsuda, T. Nakagiri, Thin Solid Films, 284-285 (1996) 152-156; O. Albrecht, T. Ginnai, A. Harrington, D. Marr-Leisy, V. Rodov, Industrial Scale Production of L-B Layers. Mol. Electron. Corp., Torrance, Calif., USA, Editor(s): Hong, Felix T., Mol. Electron.: Biosens. Biocomput., {Proc. Off. Nav. Res. Natl. Sci. Found. Symp.} (1989), Meeting Date 1988, 41-9; F. W. Embs, G. Wegner, H. H. Winter. Langmuir-Blodgett Multilayer Assembly by a Continuous Process Using a Steadily Flowing Subphase., Langmuir, 9 (1993), 1618-1621; the entire contents of each of which being hereby incorporated by reference.

One layer, bilayer, or multiples of each may be deposited as appropriate. The thicknesses of the completed LB film (not including the support) may range from 1 nm to 1,000 nm, which range includes 5, 5.5, 6, 6.5, 7, 7.5, 8, 8.5, 9, 9.5, 10, 15, 20, 25, 30, 35, 40, 45, 50, 60, 70, 80, 90, 100, 200, 300, 400, 500, 600, 700, 800, 900, and 1000, and any combination thereof.

The thin film of the present invention may be used alone or in combination with any other conventional support and/or membrane. Preferred examples of these include PDMS (poly(dimethylsiloxane)); polyalkylsiloxane; PE (poly(ethylene)); PTMSP (poly(1-trimethylsilyl-1-propyne)); TPX (poly(4-methyl-1-pentene)), ethyl cellulose, 6FDA-DAF(polyimides with hexafluoropropane dianhydride and diaminofluorene), polyimide, polyaramide, polysulfone, polysulfone (BR), cellulose acetate, cellulose, and combinations thereof.

The support may be hydrophobic or hydrophilic.

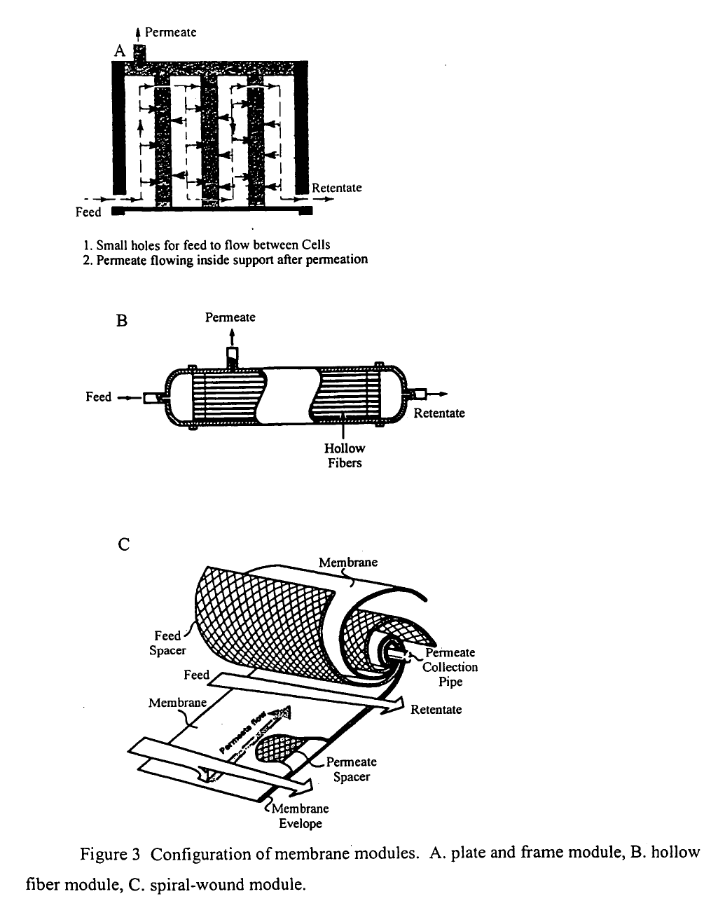

The thin film of the present invention may be used as a filter alone or more preferably in combination with a support. Preferred filter or membrane module architectures include plate and frame, spiral-wound, and hollow fiber modules. Preferred examples of these are shown in FIG. 3

The first type of membrane module is the plate and frame assembly, where membranes are close packed and paralleled. Such a module is not very space efficient but is resistant to membrane fouling. If one membrane plate fails, it can be replaced individually.

The spiral-wound module essentially includes of a large membrane envelope loosely rolled up. The feed stays outside the envelope and products are harvested from the inside via a central tube. In some embodiments, many envelopes may come out from the central tube.

Hollow fibers are essentially very small pipes, typically 300 microns in diameter with a 30-micron wall. They can be melt-spun, wet-spun or formed by interfacial polymerization. This module offers the greatest surface area per unit volume and hence it is the most space efficient type of all. The packing densities can be as high as 50%. The disadvantages are complexity of membrane formation and expensive maintenance. The LB films of the present invention may be deposited directly onto the fibers in accordance with known processes.

Another membrane module includes a frame adapted to contain multiple composite membranes, wherein the individual composite membranes are arranged in a side by side, rather than a stacked, configuration.

One preferred embodiment of the present invention includes a pressure vessel in combination with one or more composite membranes or membrane modules.

The membrane includes one or more layers of surfactant molecule film and the solid substrate, either porous or non-porous (dense). To fabricate this composite membrane, the Langmuir-Blodgett transfer method is used. Langmuir-Blodgett (LB) films are monolayer and multilayers transferred from the liquid (mostly water)-air interface onto a substrate.

The LB film/support or composite membrane configuration is not particularly limiting, and the LB films may alternate with the supports, a support/LB film/support sandwich configuration or LB film/support/LB film configuration, or any combination thereof.

The present invention makes it possible to achieve nitrogen purities of greater than 95%. This includes 95, 95.2, 95.4, 95.6, 95.8, 95.9, 96, 96.1, 96.3, 96.5, 96.7, 96.9, 97, 97.1, 97.1, 97.3, 97.5, 97.7, 97.9, 98, 98.1, 87.1, 98.3, 98.5, 98.7, 98.9, 99, 99.1, 99.1, 99.3, 99.5, 99.7, 99.9, 99.95, 99.99, 99.9995, 99.9999% and greater.

The present invention is particularly suitable for separation and/or enrichment of mixed gases in which the concentration of the target gas ranges from 0.1 to 80%, more preferably 0.5 to 50% and most preferably 1 to 10%. These ranges include all values and subranges therebetween, including 0.2, 0.7, 1, 2, 3, 4, 5, 6, 7, 8, 9, 10, 15, 20, 30, 40, 50, 60, 70 and 80%.

The present invention is particularly suitable for high gas flow processes. Nonlimiting examples of flow rates range from 0.01-500,000 scf/day, which range includes 0.01, 0.1, 1, 5, 10, 50, 100, 250, 500, 1,000, 2,500, 5,000, 10,000, 25,000, 50.000, 100,000, and 500,000 scf/day.

For industrial usage, most gas separation processes require that the selective membrane layer be extremely thin to achieve economical fluxes. Preferred support thicknesses are 10 microns or less, which range includes all values and subranges therebetween, including 10, 9, 8, 7, 6, 5.5, 5, 4.5, 4, 3.5, 3, 2.5, 2, 1.5, 1, 0.9, 0.8, 0.7, 0.6, 0.5, 0.4, 0.3, 0.2, 0.1, 0.09, 0.08, 0.07, 0.06, 0.05, 0.04, 0.03, 0.02 and 0.01 microns.

The present invention preferably includes monolayer-forming surfactants that bear multiple like-charges and water-soluble agents that bear multiple counter ions. The minimum number of total charges that is required for a given surfactant/counterion combination to form a glued LB bilayer is five; i.e., a surfactant containing two like-ionic groups and a water-soluble agent containing three counter ions, or vice versa.

The number of total charges recited herein is calculated per-ion-pair basis (surfactant and counterionic water soluble agent) as the sum of the absolute values of the positive and negative charges on the ion pair. The total charge number may be any number of five or greater, which includes 5,6, 7, 8, 9, 10, 11, 12, 13, 14, 15, 16, 17, 18, 19, 20,25, 50, 75, 100, 200, 300, 500, 700, 1000, any combination thereof, and greater.

As long as the total charge number is 5 or greater, each ion of the ion pair can have a charge of ±2 or greater. This includes all values and subranges therebetween, including ±3, 4, 5, 6, 7, 8, 9, 10, 11, 12, 13, 14, 15, 16, 17, 18, 19, 20, 25, 50, 75, 100, 200, 300, 500, 700, 1000, any combination thereof, and greater.

One embodiment of the present invention relates a method for controlling the permeability of the invention films by hydrating the films.

The present invention is particularly suitable for the following applications: nitrogen separation from air, hydrogen separation and/or recovery for example from ammonia plants and/or refineries; drying air and/or compressed air; volatile organic pollution control; refinery waste gas recovery; carbon dioxide separation and/or removal from for example natural gas; treating natural gas; oxygen or nitrogen enrichment of air; and NGL recovery (natural gas liquids, e.g., C₃₊ hydrocarbons. Combinations are possible.

The present invention is particularly suitable for the separation, recovery, and/or enrichment of the following gases and gaseous mixtures: oxygen, helium, nitrogen, carbon monoxide, carbon dioxide, water vapor, hydrogen sulfide, methane, ethane, propane, butane, air; nitrogen/oxygen; hydrogen/methane; hydrogen/nitrogen; hydrogen/carbon monoxide; water/air; VOC/air; light hydrocarbons/nitrogen; light hydrocarbons/hydrogen; carbon dioxide/methane; hydrogen sulfide/methane; hydrogen sulfide/water; water/methane; oxygen/air; NGL/liquids; C₃₊/methane; SF₆, and combinations thereof.

### EXAMPLES

Having generally described this invention, a further understanding can be obtained by reference to certain specific examples which are provided herein for purposes of illustration only and are not intended to be limiting unless otherwise specified.

Unless stated otherwise, all reagents and chemicals were obtained from commercial sources and used without further purification. Water was deionized by use of a three-stage unit consisting of one carbon and two mixed-beds (US Filter, Broadview, Ill.). The deionized water was then further purified by use of a Milli-Q Continental Water System (Millipore Corporation, Bedford, Mass.) containing four-cartridges and a final filter unit (one Super-C Carbon Cartridge, two Ion-Dx Cartridges, one Organex-Q Cartridge and one Millistak Filter Unit). The resulting water had a resistance of 15-17 MΩ and a pH of 5.5. All solvents that were used in our experiments, including chloroform, methanol, acetone, and toluene, were HPLC grade (Burdick and Jackson, Baxter).

All monolayer surface properties including surface pressure-area isotherm and surface viscosities were measured using a MGW Lauda FW-1 or a Nima 622D, film balance equipped with a computerized data acquisition station. Before each experiment, the surface of the balance was wiped and cleaned thoroughly using Kimwipes (Kimberly-Clark, Canada) together with methanol, acetone, dichloromethane and chloroform. {Caution: the latter three solvents are harmful to some polymer surfaces such as polyacetate (balance covers)} Approximately 1 L of Milli-Q water was then poured into the trough, and the surface was cleaned by sweeping the compressing barrier over it, and aspirating the surface and removing the subphase. Polymerization of 1 was achieved via ion exchange using poly (styrene sulfonate) (PSS, M.W. 70,000, Polysciences, PA) as a poly(counterion).

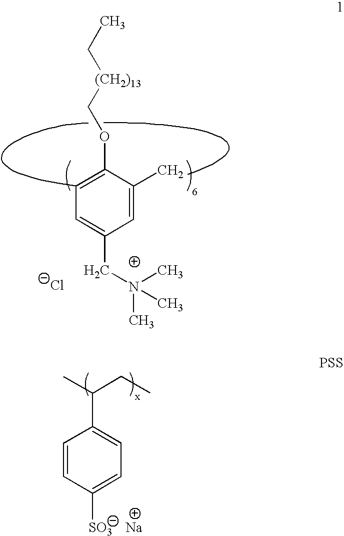

Typical aqueous solutions of PSS were prepared by dissolving 4.12 g of the sodium salt of the polymer (used as obtained) in 4 L of Milli-Q-water, which corresponds to a repeat unit concentration of 5 mM. Prior to monolayer experiments, the pH of this solution was adjusted to 8˜9 by addition of 1 N sodium hydroxide. One liter of the resulting polymer solution was poured into the film balance and used as the subphase for either monolayer characterization or for the formation of glued bilayers. The temperature of the subphase was adjusted to 25° C. and the system allowed to equilibrate for 1 h.

Solutions of 1 were prepared in chloroform/methanol (10/1, v/v) at a concentration of ca. 1 mg/mL. Exact concentrations were determined by direct weighing of aliquots after solvent evaporation using Cahn C-35 microbalance (Orion Research, MA).

A small volume of the calixarene solution (i.e., 50 μL) was then spread with extreme care onto the surface of the aqueous subphase (the surface area was ca. 600 cm²) using a 50 μL Hamilton syringe equipped with Teflon-tipped plunger. After the solvent was allowed to evaporate for a minimum of 20 min, the monolayer was compressed at a rate of ca. 25 cm²/min. Surface pressure/area isotherms were then recorded, automatically, by use of a computer. Limiting areas were determined by extrapolating the condensed phase to zero surface pressure.

In order to measure surface viscosity, a home-made canal viscometer (192 mm×40 mm×10 mm) was fabricated from Teflon. The viscometer had a slit that was located near the center, with an opening of 6 mm. The viscometer was then placed directly in front of the compressing barrier before the monolayer was compressed. After the monolayer was compressed to ca. 20 dyn/cm, the system was allowed to equilibrate for 1 h. The moving barrier was then expanded at maximum speed (120 cm²/min), while leaving the canal viscometer at its original position, and the surface pressure (Π) was recorded as a function of time (t). The viscosity 71, which is proportional to (dΠ/dt)⁻¹, can then be calculated.

Langmuir-Blodgett (LB) transfers that were used to fabricate glued bilayers were carried out in the standard manner using an MGW Lauda FW-1 film balance. After the monolayer was formed at a surface pressure of 33 dyn/cm at 25° C., the film was allowed to equilibrate for 60 min before film deposition. PTMSP membranes were mounted on a home-built magnet holder. The sample was then connected to an automatic dipper such that the surface on which the LB film was to be deposited is directly facing the compressing barrier. The dipping rate was typically 4 mm/min or 2 mm/min. At the end of the down-trip, the dipper was stopped (i.e., delayed) for 60 s˜120 s prior to the up-trip. After depositing a bilayer, the substrate was allowed to dry in air (just above the surface of the subphase) for 1˜2 h, and then placed in a closed 59 mL ointment tin (VWR, NJ), which was lined with 5.5 cm-diameter Whatman (England) filter paper, such that the LB film was facing up. The tin containing the membrane was then stored in a desiccator at room temperature for 24 h before gas permeation measurements were made. The transfer ratio (R) is defined as the decrease in monolayer area at the air-water interface divided by the geometrical surface area of the substrate.

Gas permeabilities were measured using a home built gas permeation apparatus. A membrane to be measured was placed in the permeation cell between two Viton rubber O-rings (1⅜″ I.D.×⅛″, Scientific Instrument Services, Inc.) with a support screen (4.70 cm, Millipore Corp.) and held securely with a stainless steel Quick Flange Clamp (1.5″×0.625″, Scientific Instrument Services, Inc., not shown). Membranes were always placed in the cell such that the LB film faced the high pressure side of the pressure gradient. The pure gas permeates through the membrane via an applied pressure gradient Δp, and the volumetric flow rate was recorded using a standard soap bubble method. A residue outlet was kept open such that the flux through residue outlet should be at least 10 times greater than that through the membrane to avoid concentration polarization (or stagnant layer to the permeable molecules in front of the membrane). Measurements were taken until steady-state values were achieved (typically 1 to 2 h). At least ten volumetric flow rates were recorded for each membrane and the mean and standard deviations were determined. The normalized flux or permeance Pᵢ/l was then calculated from the applied pressure gradient Δp, the area of the membrane A and the volumetric flow rate Fᵢ by the equation of

$$\frac{{P}_{i}}{1} = \frac{{F}_{i}}{A \cdot Δ p} .$$

Upon repeating this procedure for different pure gases, the selectivity α was calculated by the ratio of the pure gas normalized fluxes.
Experiment 1

5,11,17,23,29,35-hexa(chloromethyl)-37,38,39,40,41,42-hexakis-n-hexadecyloxy-calix(6)arene was synthesized in accordance with the procedure described in Yan, X.; Janout, V.; Hsu, J. T.; Regen, S. L. J. Am. Chem. Soc., 2002, 124, 10962, the entire contents of which being hereby incorporated by reference. Calix(6)arene (1) was synthesized from 5,11,17,23,29,35-hexa(chloromethyl)-37,38,39,40,41,42-hexakis-n-hexadecyloxy-calix(6)arene by direct quatemization with trimethylamine as described herein. PSS, a simple polyanion, is commercially availabile.

Compression of 1 on the surface of pure water produced stable monolayers having a limiting area of ca. 2.71±0.07 nm²/molecule. Subsequent expansion and recompression cycles yielded the same surface pressure-area curve. Compression of 1 over an aqueous subphase containing 5.0 mM of repeat units of PSS (average M_{w} ca. 70,000, Aldrich) generated a similar surface pressure-area curve. In this case, compression beyond ca. 10 dyn/cm led to significant hysteresis such that subsequent expansion resulted in a sharp decrease in surface pressure. This hysteresis implies that the polyanion enhances the cohesiveness within the monolayer by increasing the associative interactions between neighboring amphiphiles. Surface viscosity measurements, made in the absence and in the presence of PSS, also revealed enhanced cohesiveness. Thus, when a monolayer of 1 was compressed over pure water and exposed to a 6.0 mm slit opening of a canal viscometer, a precipitous decrease in surface pressure was observed. When PSS was present in the subphase, however, only a modest decrease in surface pressure with time was observed, reflecting a relatively high viscosity of the monolayer.

LB films were made as described herein. Transfer ratios were 1.0±0.1 for the downstroke and the upstroke. That PSS can be incorporated into a LB bilayer of 1 was established via ellipsometry and X-ray photoelectron (XPS) measurements. A LB bilayer of 1 was deposited onto a silyated silicon wafer using an aqueous PSS solution (30 dyn/cm). Subsequent analysis by ellipsometry revealed a film thickness of 5.64±0.04 nm. A similar bilayer that was prepared in the absence of PSS showed a thickness of 4.80±0.16 nm. Thus, the polyanion contributed ca. 0.84 nm to the thickness of the bilayer. Further analysis of the glued bilayer by XPS yielded insight into the location of the polyanion, its relative quantity, and the extent of ion exchange between PSS and 1. By using various “take-off” angles, the atomic compositions were assessed at different depths. Based on a plot of nitrogen (N) and sulfur (S) content versus take-off angle, it is clear that both of these elements are buried within the LB film. The fact that the N/S atomic ratio (0.38±0.09) shows little dependency over the entire range of take-off angles, further indicates that both of these atoms lie at similar depths. Since no chlorine could be detected by XPS, and since the atomic percentage for Na (1.23%) plus N (1.58%) is very close to the atomic percentage of S (3.16%, 90° take-off angle), it can be concluded that ion exchange is essentially complete, and that the glued film contains ca. a two-fold excess of sodium 4-styrenesulfonate groups. Finally, whereas an unglued bilayer of 1 can be readily removed from the surface of a silicon wafer by rinsing with chloroform, a PSS-glued analog remains intact. These results demonstrate that gluing significantly enhances film stability.

The quality of these glued and unglued LB films was then assessed by measuring their permeation selectivity with respect to He and N₂. For this purpose, cast films of PTMSP were used as support material. Specific experimental procedures to make the cast support films and measuring permeation selectivity were similar to those described in Hendel, R. A.; Nomura, E, Janout, V.; Regen, S. L. J. Am. Chem. Soc., 1997, 119, 6909; Hendel, R. A.; Zhang, L.-H.; Janout, V.; Conner, M. D.; Hsu, J. T.; Regen, S. L. Langmuir, 1998,14, 6545; Yan, X.; Hsu, J. T.; Regen, S. L. J. Am. Chem. Soc., 2000, 122, 11944, the entire contents of each of which being hereby incorporated by reference. Deposition of a bilayer of 1 on PTMSP resulted in reduced normalized fluxes for both He and N₂, and a He/N₂ selectivity of 1.02 (Table 1). When PSS was included in the bilayer, a significant decrease in the normalized flux for He was observed, as well as a very dramatic decrease in the normalized flux for N₂; the net result being a permeation selectivity of ca. 240. If one assumes that the resistance of this composite is equal to the resistance of the support plus the resistance of the glued bilayer, then the averaged normalized flux values for He and N₂ across this bilayer are 174 cm³/cm²-s-cm Hg and 0.57 cm³/cm²-s-cm Hg, respectively. These values translate into an intrinsic He/N₂ selectivity for the bilayer of ca. 305, which clearly reflects a very high quality film.

The average pore diameter in PTMSP films are ca. 1 nm: Yampol'ski, Y. P.; Shantorovich, V. P.; Cherrynyakovski, F. P.; Kornilov, A. I.; Plate, N. A. J. AppL Polym. Sci., 1993, 47, 85. Space filling models (CPK) indicate an outer diameter of the calix(6)arene frame of ca. 1.4 nm.

To put this permeation selectivity into perspective, a defect-free LB film made from more than 20 bilayers (60 nm in thickness) of a polymeric surfactant has shown a He/N₂ selectivity of 24 based on a solution-diffusion mechanism of permeation. The high selectivity of a single glued bilayer of 1 is believed to be due to a permanent microporous structure of the film, which is provided by the calix(6)arene framework, and its stability due to ionic cross-linking (gluing); the combination of which results in a sieving mechanism of permeation.

Compressions in the absence of 1 over aqueous PSS or EBS solutions showed negligible surface pressures.

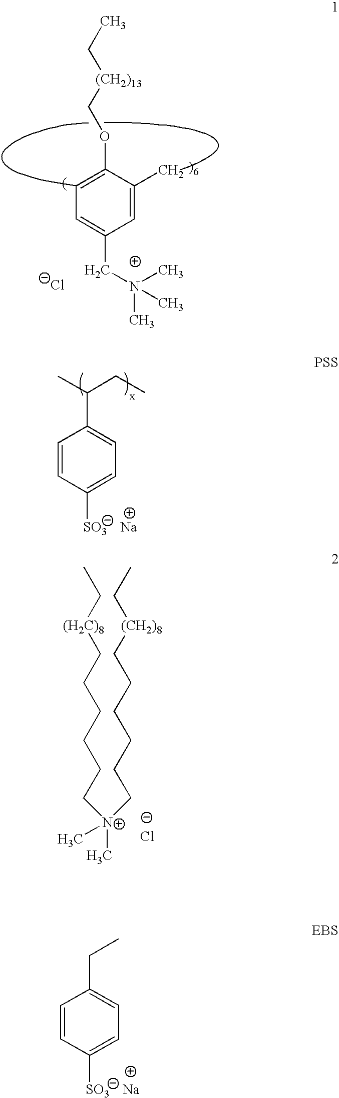

To confirm the gluing effect, a related bilayer was examined in which PSS was replaced by the sodium salt of 4-ethylbenzene sulfonate (EBS); that is, a monomer analog that is incapable of cross-linking the calix(6)arene assembly. Permeation measurements made for 1/EBS revealed a moderate reduction in the normalized flux for He and N₂, and a He/N₂ selectivity of ca. 5. From these results, it can be concluded that ionic cross-linking is, indeed, a major contributor to the extraordinary selectivity found with 1/PSS. The modest increase in selectivity of bilayers of 1/EBS relative to bilayers of 1 is presumed to reflect the additional mass that EBS constributes to the assembly. As a further control, a related membrane was examined using N,N-dimethyl-N,N-dihexadecylammonium chloride (2) in place 1. Similar to 1/EBS, this combination of singly- and multiply-charged counterions (2/PSS) precludes the possibility of ionic cross-linking. The poor selectivity observed with this membrane is a likely consequence of film defects that are formed within a less cohesive assembly. As expected, monolayers of 1/EBS and 2/PSS showed negligible surface viscosities. The fact that PSS does not signficantly increase the viscosity of monolayers of 2, but does significantly increase the viscosity in monolayers of 1, clearly reveals the “gluing” effect.

The He/N₂ selectivity of 305 observed for a single glued bilayer of 1, which is less than 6 nm in thickness, is extraordinary, unexpected and surprising. This exceeds the Knudsen diffusion limit by two orders of magnitude.

TABLE 1
Fluxes Across LB Bilayer/PTMSP Composite Membranes^{a}

| | 10⁶ P/l (cm³/cm²s-cm Hg) | | |
|---|---|---|---|
| | composite (PTMSP)^{b} | | α_{He/N2} |
| LB Bilayer | He | N₂ | (P/l)_{He/}(P/l)_{N2} |
| 1 | 513 (602) | 504 (643) | 1.02 |
| | 712 (871) | 706 (938) | 1.02 |
| 1/PSS | 132 (602) | 0.56 (643) | 235 |
| | 154 (602) | 0.67 (643) | 231 |
| | 118 (602) | 0.48 (643) | 245 |
| 1/EBS | 376 (521) | 67 (556) | 5.6 |
| | 295 (521) | 69 (556) | 4.3 |
| 2/PSS | 566 (602) | 590 (643) | 0.96 |
| | 780 (871) | 820 (938) | 0.95 |

^{a}Normalized fluxes were calculated by dividing the observed flux by the area of the membrane and the pressure gradient used (10 psig). Transfers were made using a surface pressure of 30 dyn/cm (25° C.).
^{c}Numbers in parentheses refer to the bare PTMSP; slight variations are due to variations in the thickness of the support.

Experiment 2

A single Langmuir-Blodgett bilayer of an amphiphilic calix(6)arene (1), which has been “glued together” by poly(4-styrenesulfonate) (PSS) and deposited onto poly(dimethylsiloxane) (PDMS) film, is shown to exhibit a O₂/N2 selectivity that exceeds 70. Such selectivity, and the extreme thinness of this O₂/N₂-selective membrane (i.e., 5.6 nm) are without precedent.

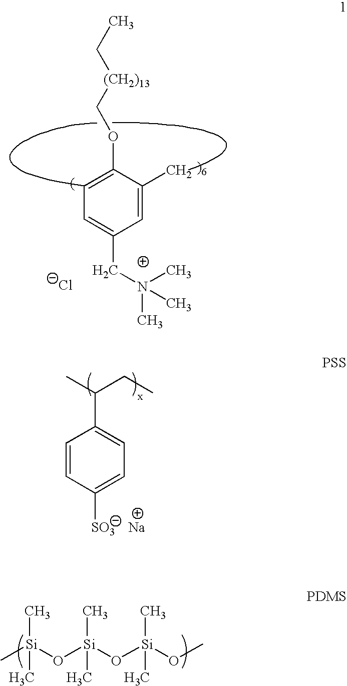

To determine whether the selective permeation pathway resides within the bilayer, itself, or within the micropores of the support material (i.e., poly(1-(trimethylsilyl)-1-propyne) (PTMSP)), which has become plugged by the calix(6)arenas, the following experiments were carried out.

Analogous composites were synthesized in which PTMSP is replaced by poly(dimethylsiloxane) (PDMS)—a nonporous elastomer that maintains a contiguous surface and is devoid of micropores. PDMS was used because of its liquid-like surface. To determine whether a smoother surface would result in improved packing of the bilayer and improved permeation selectivity, the following experiments were carried out. The experiment shows that glued bilayers made from 1 and PSS on PDMS, do, indeed, function as permeation-selective membranes. The O₂/N₂ permeation selectivities for these ultrathin membranes are stunning.

In order to minimize its barrier contribution, a thin film of PDMS was used. Since PDMS is difficult to manipulate in thicknesses that are less than ca. 40 μm, a support was prepared in the following way: A solution was prepared by dissolving 125 mg of PDMS (10% cross-linking agent (w/w), Sylgard 184, Dow Corning) in 1 mL of n-hexane. After stirring the solution for 20 h at room temperature, a 0.25 mL-aliquot was spread, directly, onto a polysulfone filter (0.2 μm pore size, 47 mm diameter, Pall Life Sciences, Ann Arbor, Mich.) that floated, freely, on a water surface. After the hexane was allowed to evaporate at the air/water interface for 48 h at room temperature, the PDMS-coated filter was placed in an oven at 60° C. for 5 h. Examination of a cross-section of the resulting surface by scanning electron microscopy revealed a ca. 13 μm-thick layer of PDMS on the filter.

Using procedures similar to those previously described, a glued LB bilayer derived from 1 and PSS was desposited onto the PDMS/polysulfone support via one vertical down-trip, followed by one vertical up-trip, using a surface pressure of 30 mN/m and a dipping speed of 2 mm/min. Pure gas permeabilities for He, Ar, O₂ and N₂ were then measured using a pressure gradient of 10 psi and experimental procedures similar to those reported elsewhere. Normalized flux (permeance) values (P/l) were obtained by dividing the gaseous flux (F) by the surface area of the membrane (A) and by the applied pressure gradient (Δp). Here, P represents the permeability coefficient that characterizes the membrane/permeant combination and l is the thickness of the membrane.

Table 2 summarizes the results obtained from three separate composite membranes. For purposes of comparison, analogous composites were also examined in which PTMSP was used as the support. In all cases, the introduction of the glued bilayer resulted in a substantial improvement in permeation selectivity relative to the bare support. Moreover, the selectivities associated with the PDMS-supported bilayers were significantly greater than those based on PTMSP. From these results, it is clear that the glued bilayer, by itself, is functioning as a highly permeation-selective barrier. The higher selectivities associated with the PDMS composites are presumed to be due to the liquid-like surface of the support and to improved packing of the bilayer. The fact that the permeances of these gases correlate with their kinetic diameters indicates that the permeation rate is primarily influenced by diffusion and not by solubility. It also indicates that permeation is not controlled by active transport processes.

TABLE 2
Permeance Across Bilayer/Support Composites^{a}

| | 10⁶ P/l (cm³/cm²-s-cm Hg) | | | | Selectivity | |
|---|---|---|---|---|---|---|
| Support | He | Ar | O₂ | N₂ | He/N₂ | O₂/N₂ |
| PDMS | (23.4) | (61.4) | (60.1) | (27.6) | 0.85 | 2.2 |
| | 22.9 | 2.4 | 4.4 | <010 | >230 | >40 |
| | 19.5 | 3.0 | 6.0 | <0.10 | >200 | >60 |
| | 18.4 | 5.4 | 7.4 | <0.10 | >180 | >70 |
| PTMSP | (600) | — | (880) | (650) | 0.92 | 1.35 |
| | 181 | 6.4 | 13.4 | 0.432 | 420 | 9.7 |
| | 100 | 4.0 | 10.0 | 1.7 | 59 | 5.9 |
| | 230 | 7.1 | 14.8 | 1.9 | 121 | 7.8 |

^{a}Permeance values for glued bilayers derived from 1 and PSS; numbers in parentheses refer to the bare PTMSP or bare PDMS on polysulfone, having average thicknesses of ca. 13 μm. All measurements were made at ambient temperatures. Values were obtained from 5-10 independent measurements; the error in each case was ±5%. In all cases, N₂ values were reproduced after the entire series of gases was examined.

The magnitude of the O₂/N₂ selectivities for glued bilayers of 1 on PDMS is extraordinary, unexpected and surprising. These membranes and their production are quite reproducible. No other membrane material is known having such selectivity. Prior to the present invention, the highest O₂/N₂ permeation selectivity that has been recorded for an organic membrane was 30. The correctness of this value, however, has been the subject of considerable debate. The most commonly accepted value of high O₂/N₂ selectivity lies in the vicinity of ca. 13.0.

If one assumes that the resistance of a glued bilayer/PDMS composite is equal to the resistance of the support plus the resistance of the bilayer, and if an ellipsometric thickness of the bilayer is assumed (i.e., 5.6 nm), then the permeability coefficient for O₂ for the membrane showing a O₂/N₂ selectivity>70 is 0.02 Barrers. Such a value clearly places the performance of this single glued bilayer well above the upper boundary. While not wishing to be bound by theory, this fact, in and of itself, is believed to imply that the membrane is functioning like a molecular sieve that contains a monodisperse array of micropores.

The unique permeation properties of glued bilayers of 1 on PDMS, together with their extreme thinness, shows that such materials are particularly suitable for novel membranes for the gas separation and particularly the separation of O₂ and N₂ from air, and also for the separation of of H₂ from N₂. Storage of a glued bilayer of 1 on PDMS in the laboratory ambient for a period of one month did not result in any significant changes in permeability.

As a comparison, membranes were fabricated using LB films of conventional (non-ionically crosslinked) surfactants. Table 3 below shows the results obtained using arachidic acid (AA) alone and in combination with Cd²⁺. Results obtained with stearoylamidoxime (SA) are also shown.

TABLE 3
Flux of He and N₂ Through Conventional
Surfactant/PTMSP Composites

| | | He | N₂ | He/N₂ (α) |
|---|---|---|---|---|
| Surfactant | monolayers | 10⁶P/l (cm³/cm²-s-cm Hg) | | (composite) |
| none | 0 | 530 | 579 | 0.91 |
| | 0 | 474 | 530 | 0.90 |
| AA | 4 | 519 | 592 | 0.88 |
| | 4 | 537 | 592 | 0.91 |
| AA/Cd²⁺ | 4 | 532 | 603 | 0.88 |
| | 4 | 528 | 586 | 0.90 |
| SA | 2 | 521 | 585 | 0.89 |
| | 4 | 541 | 592 | 0.91 |
| | 4 | 499 | 571 | 0.88 |

Table 4 shows the effects of hydration on the permeation properties of LB films made from a calx(6)arene amidoxime that has six hexadecyl chains.

TABLE 4
Hydration Effects on the Permeability of
Calix(6)arene/PTMSP films

| | | | | |
|---|---|---|---|---|
| Monolayers | | 1/F | P/l × 10⁶ | |
| (number) | Permeant | (s/mL) | cm³/(cm²-s-cmHg) | (P/l)_{He}/(P/l)_{N2} |

Initial Exposure to Dry Permeant

| | | | | |
|---|---|---|---|---|
| 0 | He | 2.8 | 738 | 0.90 |
| | N₂ | 2.55 | 810 | |
| 6 | He | 24 | 86 | 73.6 |
| | N₂ | 1766 | 1.17 | |

Subsequent Exposure to Moist Permeant

| | | | | |
|---|---|---|---|---|
| 0 | He | 2.8 | 737 | 0.90 |
| | N₂ | 2.51 | 823 | |
| 6 | He | 83.3 | 24.8 | 20.8 |
| | N₂ | 1733 | 1.19 | |

Return to Dry Permeant

| | | | | |
|---|---|---|---|---|
| 0 | He | 2.83 | 730 | 0.90 |
| | N₂ | 2.45 | 807 | |
| 6 | He | 24 | 84.9 | 72.6 |
| | N₂ | 1766 | 1.17 | |

The entire contents of each of the references cited hereinabove and below is incorporated herein by reference, the same as if set forth at length.

Brandrup, J.; Immergut, E. H.; Grulke, E. A. Polymer Handbook, 4^{th} Ed.; John Wiley & Sons: New York, 1998.

Shawaphun, Sarinya, “Self-Assembled Surfactant-Polymer Composite Membranes For Gas Separations”, Ph.D. Thesis, Lehigh University, 2002.

Yan, X.; Janout, V.; Hsu, J. T.; Regen, S. L., J. Am. Chem. Soc., 2003, 125, 0000.

Merkel, T. C.; Bondar, V. I.; Nagal, K.; Freeman, B. D.; Pinnau I. Journal of Polymer Science:Part B: Polymer Physics, 2000, 38, 415.

Breck, D. W., “Zeolite Molecular Sieves: Structure, Chemistry and Use”, Wiley, NY, 1973, p 626.

Mahaj an, R.; Zimmerman, C. M.; Koros, W. J., “Polymer Membranes for Gas and Vapor Separations”, ACS Symp. Ser., 1999, 733, 277.

Robeson, L. M. J. Membr. Sci., 1991, 62, 165.

Freeman, B. D. Macromolecules, 1999, 32, 375.

Anderson, M. R.; Mattes, B. R.; Reiss, H.; Kaner, R. B. Science, 1991, 252, 1412.

Kuwabata, S.; Martin, C. R. J. Membr. Sci., 1994, 91, 1.

Lee, Y. M.; Ha, S. Y.; Lee, Y. H.; Suh, D. H.; Hong, S. Y. Ind. Eng., Chem. Res., 1999, 38, 1917.

Seo, Y.; Hong, S. U.; Lee, B. S. Angew. Chem., Int. Ed., 2003, 42, 1145.

Rose, G. D.; Quinn, J. A., Science, 1968, 159, 636.

Albrecht, O.; Laschewsky, A.; Ringsdorf, H. Macromolecules, 1984, 17, 937.

Higashi, N.; Kunitake, T.; Kajiyama, T. Polym. J.,1987, 19, 289.

Stroeve, P.; Coelho, M. A. N.; Dong, S.; Lam, P.; Coleman, L. B.; Fiske, T. G.; Ringsdorf, H.; Schneider, J. Thin Solid Films, 1989, 180, 241.

Bruinsma, P.; Stroeve, P. Thin Solid Films, 1994, 244, 958.

Tebbe, H.; Ackem, F. van; Tieke, B. Macromol. Chem. Phys., 1995, 196, 1475.

Zhou, P.; Samuelson, L.; Alva, S.; Chen, C.-C.; Blumenstein, R. B.; Blumenstein, A. Macromolecules, 1997,30,1577.

Steehler, J. K.; Lu, W.; Kemery, P. J.; Bohn, P. W. J. Membrane Sci., 1998, 139, 243.

Marek, M.; Brynda, E.; Pientka, Z.; Brozova, L. Macromol. Rapid Commun., 1998, 19, 53.

Maoz, R.; Sagiv, J. J. Colloid Interface Sci. 1984, 100, 465.

Obviously, numerous modifications and variations of the present invention are possible in light of the teachings herein. It is therefore to be understood that within the scope of the appended claims, the invention may be practiced otherwise than as specifically described herein.

1. A Langmuir-Blodgett (LB) thin film, comprising:
at least one molecular layer, comprising one or more monolayer-forming surfactant molecules having a first ionic charge, ionically cross-linked with at least one water-soluble agent having a second ionic charge;
wherein a total amount of said first and second charges is at least 5;
and wherein each of said first and second charges is independently 2 or greater.

2. The thin film of claim 1, wherein said molecular layer comprises a molecular monolayer, a molecular bilayer, or a combination thereof.

3. The thin film of claim 1, wherein said monolayer-forming surfactant is one or more cyclic or acyclic surfactants.

4. The thin film of claim 1, wherein said monolayer-forming surfactant is one or more cyclic surfactants having a formula selected from the group consisting of the following formulas: 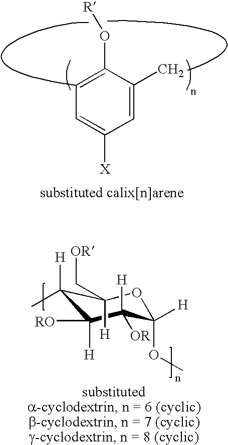
wherein R′=C₄-C₂₀ is linear or branched, saturated or unsaturated alkyl, aryl, and/or acyl group;
wherein n is 4 to 8; and
wherein X=a trimethylamnonium, trimethylammoniummethyl, trimethylphosphonium, methylene trimethylphosphonium, mercuronium, sulfonium, sulfate, carboxymethyl, carboxylate, and combinations thereof;
and wherein R=sulfate or carboxymethylene.

5. The thin film of claim 1, wherein said monolayer-forming surfactant is one or more acyclic surfactants having a formula selected from the group consisting of the following formulas: 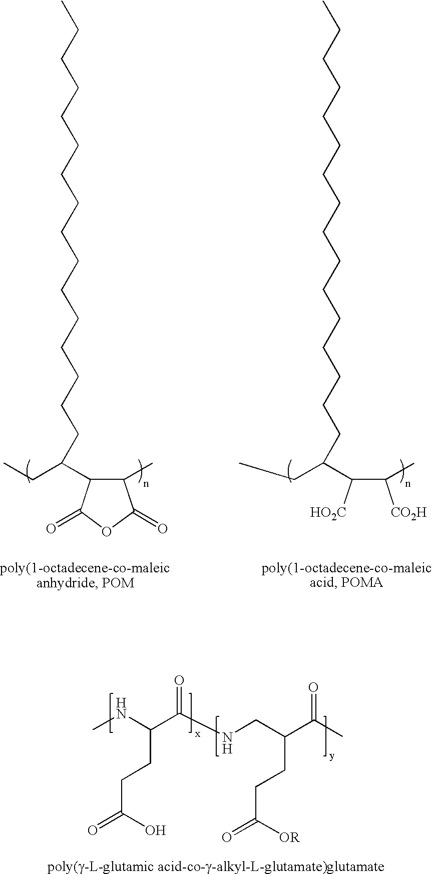
wherein n is 2 to 10,000;
x is for a mole fraction of 0.1 to 0.8, based on the polymer; and y is for a mole fraction of 0.2 to 0.9, based on the polymer.

6. The thin film of claim 1, wherein the water-soluble agent is one or more selected from the group consisting of
poly(4-styrene sulfonic acid)
poly(4-styrenesulfonic acid-co-maleic acid)
poly(styrene-co-maleic acid)
Acid Blue 113
Acid Blue 92
Ponceau S
Brilliant Black BN
poly(allyl)amine
poly(diallyldimethylammonium chloride)
Ca⁺⁺
Fe(II)
Fe(III)
Ti(IV)
Hg(II),
and combinations thereof.

7. The thin film of claim 1, wherein the monolayer-forming surfactant is calix(6)arene and the water-soluble agent is poly(4-styrenesulfonate).

8. An article, comprising:
the thin film of claim 1 in contact with at least one support.

9. The article of claim 8, wherein the support is one or more selected from the group consisting of PDMS (poly(dimethylsiloxane)); polyalkylsiloxane; PE (poly(ethylene)); PTMSP (poly(1-trimethylsilyl-1-propyne)); TPX (poly(4-methyl-1-pentene)), ethyl cellulose, 6FDA-DAF(polyimides with hexafluoropropane dianhydride and diaminofluorene), polyimide, polyaramide, polysulfone, polysulfone (BR), cellulose acetate, cellulose, and combinations thereof.

10. The article of claim 8, wherein said molecular layer comprises a molecular monolayer, a molecular bilayer, or a combination thereof.

11. The article of claim 8, wherein said monolayer-forming surfactant is one or more cyclic or acyclic surfactants.

12. The article of claim 8, wherein said monolayer-forming surfactant is one or more cyclic surfactants having a formula selected from the group consisting of the following formulas: 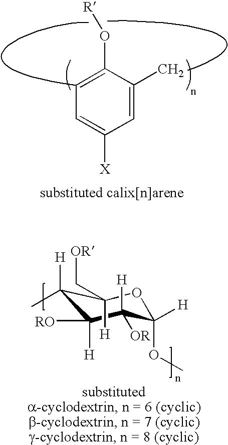
wherein R′=C₄-C₂₀ is linear or branched, saturated or unsaturated alkyl, aryl, and/or acyl group;
wherein n is 4 to 8; and
wherein X=a trimethylammonium, trimethylammoniummethyl, trimethylphosphonium, methylene trimethylphosphonium, mercuronium, sulfonium, sulfate, carboxymethyl, carboxylate, and combinations thereof;
and wherein R=sulfate or carboxymethylene.

13. The article of claim 8, wherein said monoiayer-forming surfactant is one or more acyclic surfactants having a formula selected from the group consisting of the following formulas: 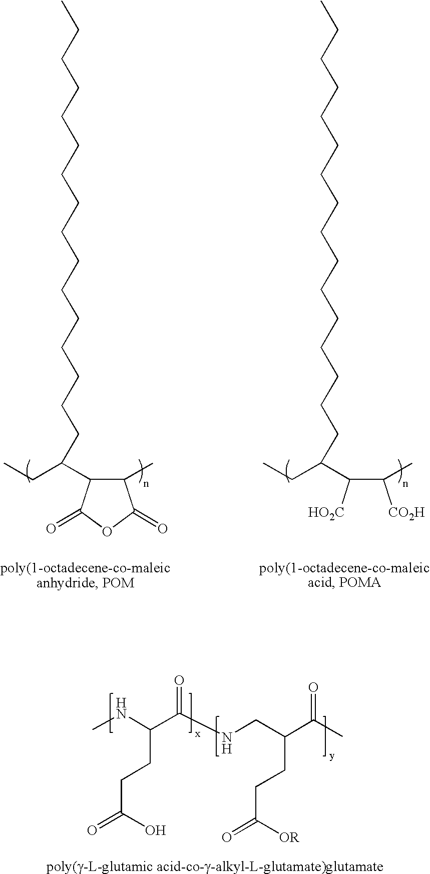
wherein n is 2 to 10,000;
x is for a mole fraction of 0.1 to 0.8, based on the polymer; and y is for a mole fraction of 0.2 to 0.9, based on the polymer.

14. The article of claim 8, wherein the water-soluble agent is one or more selected from the group consisting of
poly(4-styrene sulfonic acid)
poly(4-styrenesulfonic acid-co-maleic acid)
poly(styrene-co-maleic acid)
Acid Blue 113
Acid Blue 92
Ponceau S
Brilliant Black BN
poly(allyl)amine
poly(diallyldimethylammonium chloride)
Ca⁺⁺
Fe(II)
Fe(III)
Ti(IV)
Hg(II),
and combinations thereof.

15. The article of claim 8, wherein the monolayer-forming surfactant is calix(6)arene and the water-soluble agent is poly(4-styrenesulfonate).

16. The article of claim 8, wherein the monolayer-forming surfactant is calix(6)arene, the water-soluble agent is poly(4-styrenesulfonate), and the support is poly(1-(trimethylsilyl)-1-propyne) (PTMSP).

17. The article of claim 8, wherein the support is hydrophobic or hydrophilic.

18. A method for making the thin film of claim 1, comprising:
contacting at least a portion of a monolayer of said surfactant with said agent, and ionically cross-linking said monolayer.

19. A method for making the article of claim 8, comprising:
contacting said thin film with said support.

20. A method, comprising:
contacting the thin film of claim 1 with a mixture of gases.

21. The method of claim 20, wherein the mixture comprises one or more gases selected from the group consisting of oxygen, helium, nitrogen, carbon monoxide, carbon dioxide, water vapor, hydrogen sulfide, methane, ethane, propane, butane, air; nitrogen/oxygen; hydrogen/methane; hydrogen/nitrogen; hydrogen/carbon monoxide; water/air; VOC/air; light hydrocarbons/nitrogen; light hydrocarbons/hydrogen; carbon dioxide/methane; hydrogen sulfide/methane; hydrogen sulfide/water; water/methane; oxygen/air; NGL/liquids; C₃₊/methane; SF₆, and combinations thereof.

22. A method, comprising:
contacting the article of claim 8 with a mixture of gases.

23. A method for stabilizing a Langmuir-Blodgett film, comprising:
contacting at least one molecular layer comprising one or more monolayer-forming surfactant molecules having a first ionic charge with at least one water-soluble agent having a second ionic charge;
wherein a total amount of said first and second charges is at least 5;
and wherein each of said first and second charges is independently 2 or greater;
to ionically crosslink said molecular layer.

24. A method, comprising:
hydrating the thin film of claim 1, to form a hydrated thin film; and
contacting the hydrated thin film with a mixture of gases.

25. An article, comprising:
the thin film of claim 1, disposed within a pressure vessel having at least one inlet and at least one outlet.

26. A compound having the formula: 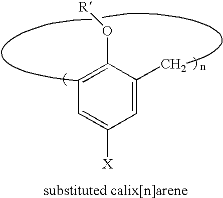
wherein R′=C₄-C₂₀ is linear or branched, saturated or unsaturated alkyl, aryl, and/or acyl group;
wherein n is 4 to 8; and
wherein X=a trimethylammonium, trimethylammoniummethyl, trimethylphosphonium, methylene trimethylphosphonium, sulfonium, sulfate, carboxymethyl, carboxylate, and combinations thereof.

27. The compound of claim 26, which has the following structure: [chemical structure]
